(19) United States
(12) Patent Application Publication
(10) Pub. No.: US 2010/0010782 A1
(43) Pub. Date: Jan. 14, 2010

(54) Systems and Methods of Selecting a CAE Analysis Solver with Appropriate Numerical Precision in Each of a Series of Hierarchically Related Engineering Simulations

(75) Inventors: Xin Hai Zhu, Pleasanton, CA (US); John O. Hallquist, Livermore, CA (US)

Correspondence Address: ROGER H. CHU, 19499 ERIC DRIVE, SARATOGA, CA, 95070, US

(73) Assignee: LIVERMORE SOFTWARE TECHNOLOGY CORPORATION, Livermore, CA (US)

(21) Appl. No.: 12/170,267

(22) Filed: Jul. 9, 2008

(51) Int. Cl. G06F 17/50; G06F 17/12

(52) U.S. Cl. 703/1; 703/2

(57) ABSTRACT

Systems and methods of selecting a solver with appropriate numerical precision in each of a series of hierarchically related engineering simulations are described. According to an exemplary embodiment of the present invention, a series of hierarchically related engineering simulations comprises a sequence of finite element analyses for designing and analyzing a structural product. An input file describing the structural product and type of engineering simulation is received. Each different type of engineering simulations is checked to determine which solver with appropriate numerical precision (i.e., single or double precision) is used. A corresponding executable module (e.g., Finite Element Analysis software module) is then used for performing the analysis of that engineering simulation. The process repeats until all of the engineering simulations have been conducted in the entire sequence.

### FIELD OF THE INVENTION

The present invention generally relates to mechanical computer aided engineering (CAE) analysis, more particularly to systems and methods of selecting a CAE solver with appropriate numerical precision in a series of hierarchically related engineering simulations.

### BACKGROUND OF THE INVENTION

Computer-aided engineering simulations have been used for designing structures (e.g., automobile, airplane, etc.). Many of the simulations is performed using Finite element analysis (FEA), which is a computerized method widely used in industry to model and solve engineering problems relating to complex systems. FEA derives its name from the manner in which the geometry of the object under consideration is specified. With the advent of the modern digital computer, FEA has been implemented as FEA software. FEA software can be classified into two general types, implicit FEA software and explicit FEA software. Implicit FEA software uses an implicit equation solver to solve a system of coupled linear equations. Such software is generally used to simulate static or quasi-static problems. Explicit FEA software does not solve coupled equations but explicitly solves for each unknown assuming them uncoupled. Explicit FEA software usually uses central difference time integration which requires very small solution cycles or time steps for the method to be stable and accurate. Explicit FEA software is generally used to simulate short duration events where dynamics are important such as impact type events.

Users of FEA software create a FEA model of the system to by analyzed using a number of elements and nodes. Each of the elements represents a finite region of the system. Within each element, the unknown quantity is assumed to take a simple form within the domain of the element. For the explicit FEA software, the unknown quantities are usually accelerations. For the implicit FEA software, the unknown quantities are generally displacements, or others.

By assuming a simple form of the unknowns within an element, and by using many elements, complex behaviors can be simulated within a reasonable time frame with the FEA software. One simple example is a linear spring element with the displacement at the ends of the spring as the unknown quantity. The displacement field is assumed to vary linearly along the length of the spring. Therefore, if we solve for the displacement at the ends of the spring, we can easily evaluate the displacement at any point along the spring. The compatible strain and stress fields for a linear spring element are constant over the element length and are easily evaluated from the end displacements and material properties.

Points on the element where the unknowns are solved are called nodes. The linear spring has a node at each end. If we place a third node at the middle of the spring element, the displacement field could then be assumed to vary as a quadratic function and the compatible strain and stress fields would be linear. The common element types are solid elements for modeling volumes, shell elements for modeling thin parts dominated by bending, beam elements for modeling beams, and spring or truss elements for modeling springs and trusses. Each element is assigned a material type and appropriate material properties. By choosing appropriate material types and properties, metals, plastics, foams, soil, concrete, rubber, glass, fluids and many other materials can be modeled. The user must also specify the boundary conditions, loads, and initial conditions to complete the model. To accurately simulate complex system behavior, many elements are needed. For example, typical FEA models of entire automobile are made of more than 500,000 elements. Many of the analysis may require many hours, sometimes days, of dedicated computer time even using the state-of-the-art multi-processor computer system.

Once the FEA model is defined, FEA software can perform a simulation of the physical behavior under the specified loading or initial conditions. FEA software is used extensively in the automotive industry to simulate front and side impacts of automobiles, occupant dummies interacting with airbags, and the forming of automobile body parts from sheet metal. Such simulations provide valuable insight to engineers who are able to improve the safety of automobiles and to bring new models to the market more quickly.

As the FEA advances, more and more of the FEA analyses of related events are performed. Today, these related events are simulated individually. In other words, each event is analyzed with a new computer aided simulation. Engineers or users must possess a lot of knowledge of each of the related event to be able to conduct a proper sequence of analyses. In particular, some of knowledge is problem dependent, which is not portable to another simulation. Therefore, it is desirable to have an improved method that relies less of the users' knowledge.

The FEA software is generally run on a computer system. As almost all of the computer-aided engineering analysis, the computation is performed using floating-point arithmetic in a computer system. The floating-point describes a numerical representation system in which a string of digits (or bits) represents real number. The range of floating-point numbers depends on the number of bits used for representation of the significand (the significant digits of the number) and for the exponent. Therefore, the more digits or bits are used for a real number, the more precision of the real number can be retained.

In general, there are two formats: single precision and double precision as defined in many of the standards (e.g., IEEE 754). The single precision occupies 32 bits (or 4 bytes) and has a significand precision of 24 bits (about 7 decimal digits), while the double precision occupies 64 bits (or 8 bytes) with 53-bit significand (about 16 decimal digits).

Depending upon the nature of the computations, either of these two formats may be selected to accomplish desired tasks. However, care must be taken when make such selection. For example, implicit FEA requires solving a system of simultaneous equations which includes many floating-point operations involving ‘division’ resulting into truncation and round-off errors. It is therefore important to ensure a double precision is chosen. On the other hand, explicit FEA does not require solving simultaneous equations, single precision may be used for faster execution while maintaining valid solution.

Since these two formats are related to computer architecture, majority of the users of the finite element analysis software are mechanical engineers, who may not be aware of the implication as result of selecting an inappropriate numerical precision format. Incorrect choices have been made very often. As a result, either valuable computing resources are wasted or incorrect analysis results are obtained. This situation gets worse when a series of related engineering simulations is performed, when some of the simulations should be performed in one numerical precision while others in a different one.

It would therefore further desirable to have improved systems and methods of selecting a solver with appropriate numerical precision in each of a series of hierarchically related engineering simulations.

### BRIEF SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

Systems and methods of selecting a solver with appropriate numerical precision in each of a series of hierarchically related engineering simulations are disclosed. According to one aspect of the present invention, a series of hierarchically related engineering simulations comprises a sequence of finite element analyses for designing and analyzing a structural product. For example, metal forming of an automobile part may require a number of engineering simulations to represent several phases of the metal forming: a) gravity loading; b) binder wrapping; c) punch lowering; d) binder releasing for springback; and e) edge flanging and hamming.

Each of these phases of the metal forming process requires a different mechanical engineering design consideration. For example, the gravity loading and the springback are static loads that should be analyzed with a non-linear static implicit solver using double precision. The punch lowering phase should be analyzed with a non-linear explicit solver using single precision. As the series of engineering simulations become more complex, these solver selections will become more confusing. Instead of manually selecting solvers, a predefined sequence with proper solver including appropriate precision is provided to users ensuring accuracy of the engineering simulations can be achieved.

According to another aspect of the present invention, an input file describing the structural product and type of engineering simulation is received. Each different type of engineering simulations is checked to determine which solver with appropriate numerical precision (i.e., single or double precision) is used. A corresponding executable module (e.g., FEA analysis software module) is then used for performing the analysis of that engineering simulation. The process repeats until all of the engineering simulations have been conducted in the entire sequence. Optionally a single simulation sequence command is defined to trigger the series of hierarchically related engineering simulations.

According to one embodiment, the present invention is a method of selecting a finite element analysis (FEA) solver with appropriate numerical precision in a series of hierarchically related engineering simulations comprises at least the following steps: (a) receiving an input file at a computer system with both single precision and double precision FEA executable modules installed thereon, wherein the input file is for a particular one of the series of hierarchically related engineering simulations; (b) extracting a simulation type from the received input file; (c) determining which one of the single and the double precision FEA modules to be selected according to a predefined correlation of the simulation type and FEA module type; (d) performing FEA using the selected FEA module for said particular one of the series of hierarchically related engineering simulations; and (e) repeating steps (a)-(d) until all simulations have been performed in the series of hierarchically related engineering simulations. The method further comprises defining a simulation sequence command in the input file as a single identifier to trigger the series of hierarchically related engineering simulations.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a diagram showing an exemplary group of hierarchical related engineering simulations;

FIGS. 2A and 2D collectively show a sequence of two-dimensional views of hierarchically related engineering simulations;

FIG. 3 is a diagram showing an exemplary computer system loaded with two executables with different numerical precisions;

FIG. 4 is a diagram showing an exemplary data structure of a single precision floating point number in a computer system;

FIG. 5 is a diagram showing an exemplary data structure of a double precision floating point number in a computer system;

FIG. 6 is a flowchart illustrating an exemplary process of selecting a CAE analysis solver with appropriate numerical precision in a series of hierarchically related engineering simulations; and

FIG. 7 is a functional block diagram showing an exemplary computer, in which the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

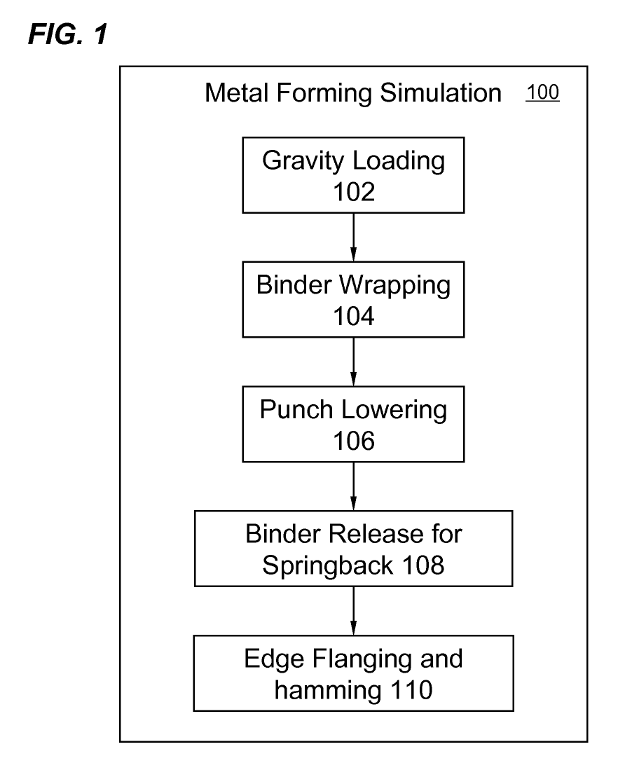

Embodiments of the present invention are discussed herein with reference to FIGS. 1-7. However, those skilled in the art will readily appreciate that the detailed description given herein with respect to these figures is for explanatory purposes as the invention extends beyond these limited embodiments.

Referring first to FIG. 1, which lists an exemplary series of hierarchically related engineering simulations. The exemplary series is a metal forming simulation 100 (e.g., forming an automobile part from sheet metal). Metal forming simulation 100 comprises a number of phases: 1) gravity loading 102, 2) binder wrapping 104, 3) puncn lowering 106, 4) binder release for springback 108 and 5) edge flanging and hamming 110.

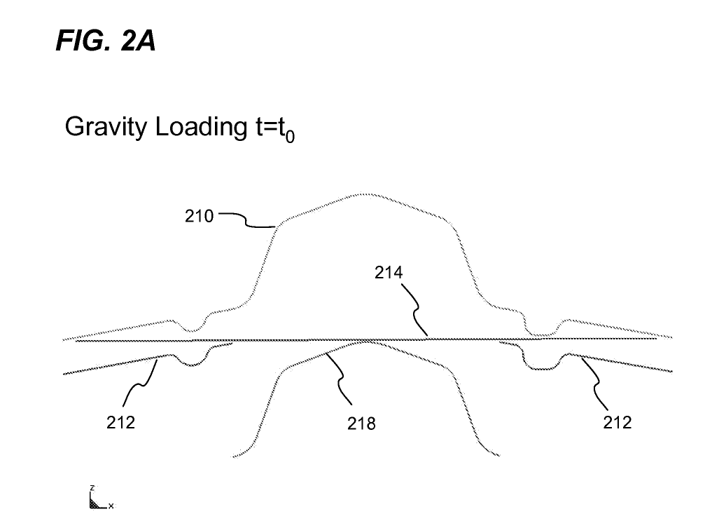

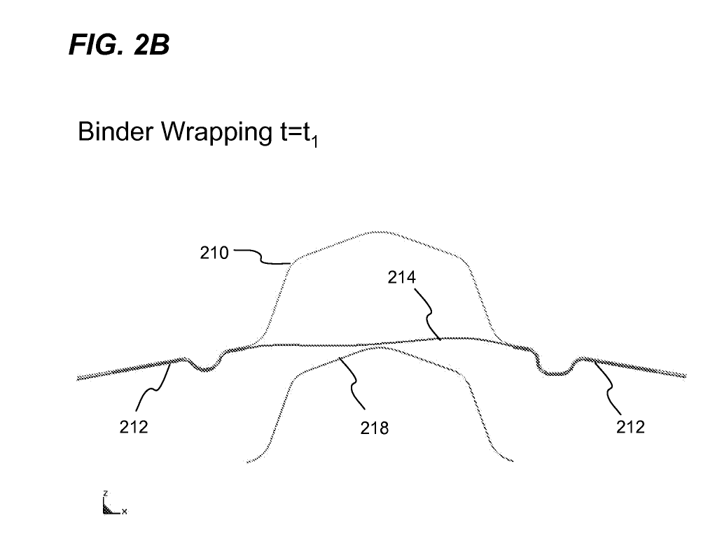

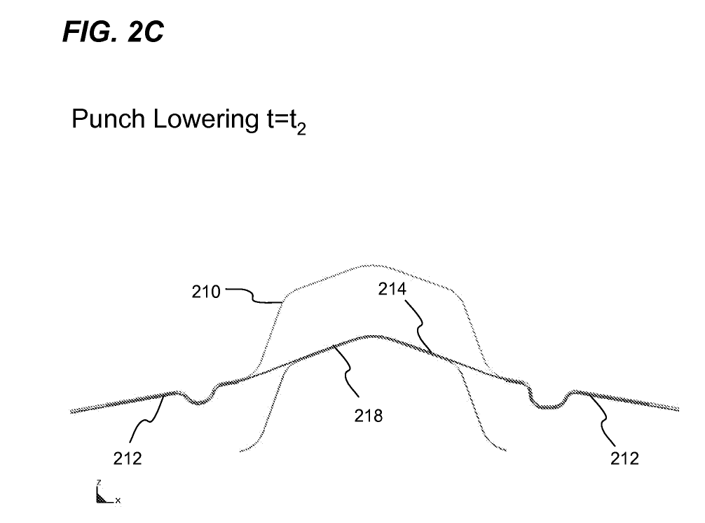

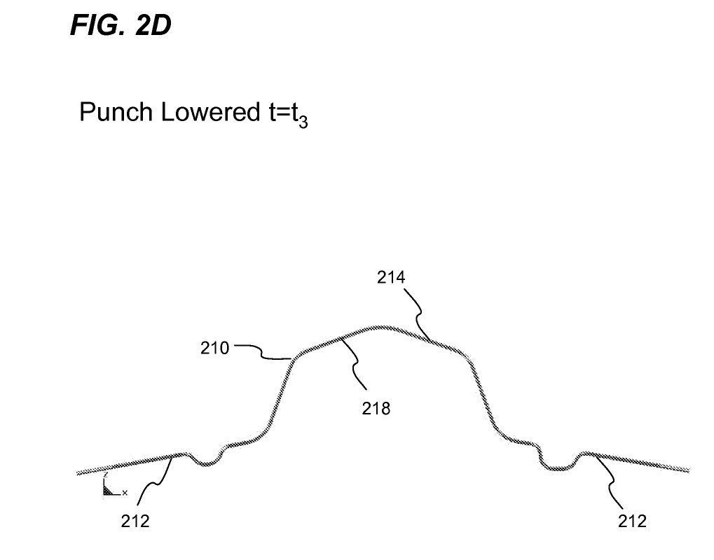

Some of these phases are depicted in FIGS. 2A-2D. For illustration simplicity, diagrams shown in FIGS. 2A-2D are in two-dimensional elevation views even though the objects may be three-dimensional. The gravity loading phase 102 is when a blank sheet metal 214 is laid on top of a die 218 between punch 210 and binder 212 shown in FIG. 2A at time to. Only loads on the blank sheet metal 214 are the gravity load due to the mass of the blank 214 itself. The gravity loading phase 102 can be analyzed with a static solution using an implicit FEA solver in higher numerical precision (i.e., double precision).

FIG. 2B shows the next phase—binder wrapping 104 at time t₁. It can be seen that the binder 212 is wrapped over to hold down the blank 214 at the perimeter of the punch 210. This binder wrapping phase 104 is preferably analyzed with an explicit FEA using lower numerical precision (i.e., single precision). Then, the punch 210 is lowered or pushed onto the blank 214 as shown in FIGS. 2C and 2D at time t₂ and t₃, respectively. Shown in FIG. 2C, the punch 210 has been lowered about half way down its depth. It is evident that the blank 214 has been bent over top of the die 218. When the entire punch 210 is lowered to the blank 214 shown in FIG. 2D, the blank 214 is formed to a predetermined shape of the die 218. The punch lowering phase 106 is also preferably analyzed with an explicit FEA with single precision.

FEA analyses of next two phases (i.e., springback 108 and edge flanging 110, not shown graphically) of metal forming simulation 100 are conducted thereafter. The springback phase108 may be conducted in either implicit or explicit FEA, while edge flanging 110 is conducted in explicit. These simulations are hierarchically related because they must be performed in the order defined, for example, gravity loading is before binder wrapping, punch lowering before the springback, etc. The deformed shape of the blank sheet metal 214 at the end of each phase becomes the new geometry in the input file for the next phase. The final geometry of the blank 214 should ideally be the structural part or structure desired to produce.

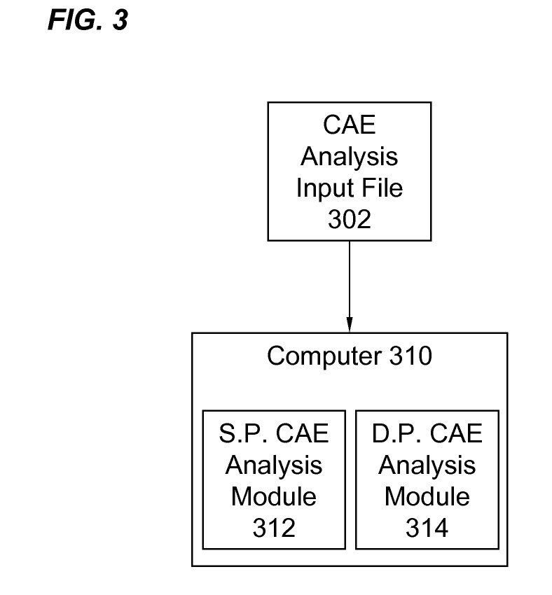

Referring now to FIG. 3, which shows relationship between a CAE analysis input file 302 and a computer 310 with CAE analysis software installed thereon. The CAE analysis input file 302 comprises a numerical representation of a structural product (e.g., automobile part) to be used in engineering simulation. The input file 302 generally includes a set of nodes used for defining finite elements that represent the structural product, a set of material properties, a set of rules defining structural behaviors, etc. In general, a particular type of simulation is also included in the input file. Optionally a single simulation sequence command may be defined in the input file to trigger the series of hierarchically related engineering simulations. The input file 302 is first read into a computer 310 with CAE software installed. The CAE software module may include one or more software modules (e.g., single-precision CAE analysis module 312 and double-precision CAE analysis module 314). It is noted that there can be additional other types of software modules installed on the computer 310. A series of hierarchically related engineering simulation can be conducted on a computer 310, because both numerical precision modules are installed and available during the simulation.

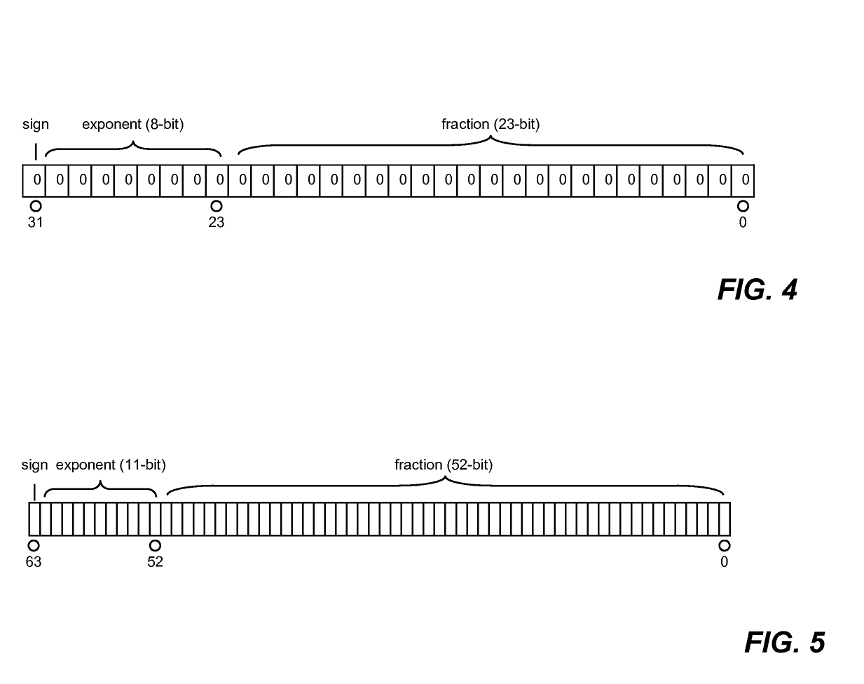

FIG. 4 is a diagram showing data structure of a single precision floating point number in 32-bit, while FIG. 5 a double precision in 64-bit. A higher numerical precision is required generally in implicit FEA, such that enough numerical precision is allocated to endure truncation and round-off errors occurred during computation. In explicit FEA, there is no simultaneous equations solving, therefore, a single precision version would be enough to carry out the analysis.

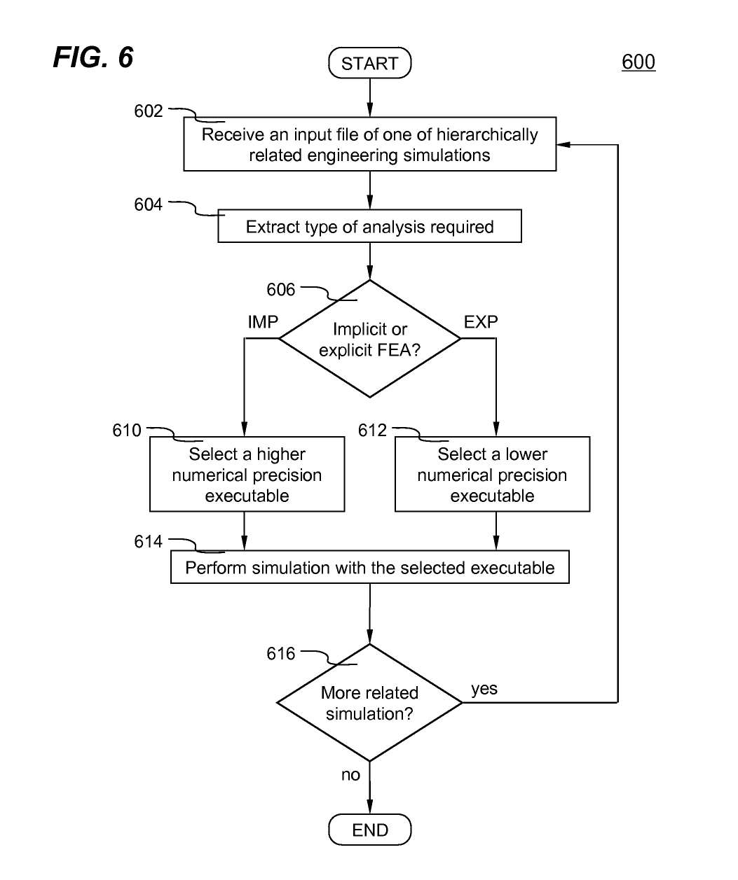

According to one embodiment of the present invention, a flowchart of an exemplary process 600 of selecting a CAE solver with appropriate numerical precision in each of a series of hierarchically related engineering simulations is shown in FIG. 6. The process 600 is implemented in software.

Process 600 starts by receiving, at a computer (e.g. computer 310), an input file of a first one of a series of hierarchically related engineering simulations at step 602. Next, type of simulation is extracted from the input file at step 604. For example, gravity loading is determined by a module installed on the computer 310 from the input file 302. Once the type of simulation is obtained, process 600 moves to decision 606. It is determined whether an implicit or explicit FEA should be used for the simulation. If ‘Implicit (IMP)’ is determined, process 600 moves to step 610 to select a higher numerical precision executable module (e.g., a double precision module 314). Otherwise, a lower numerical precision module (single precision module 312) is selected at step 612 following the ‘Explicit (EXP)’ branch. Decision 606 may be implemented by a look-up table that correlates each type of simulation with a corresponding solver or executable with appropriate numerical precision.

Next, at step 614, the particular simulation specified in the input file is performed with the selected executable module. Process 600 then checks whether there are more simulations to be performed at decision 616. If ‘yes’, process 600 moves back to step 602 for a corresponding input file and repeat the steps 602-614 until decision 616 has become ‘no’. Process 600 ends thereafter.

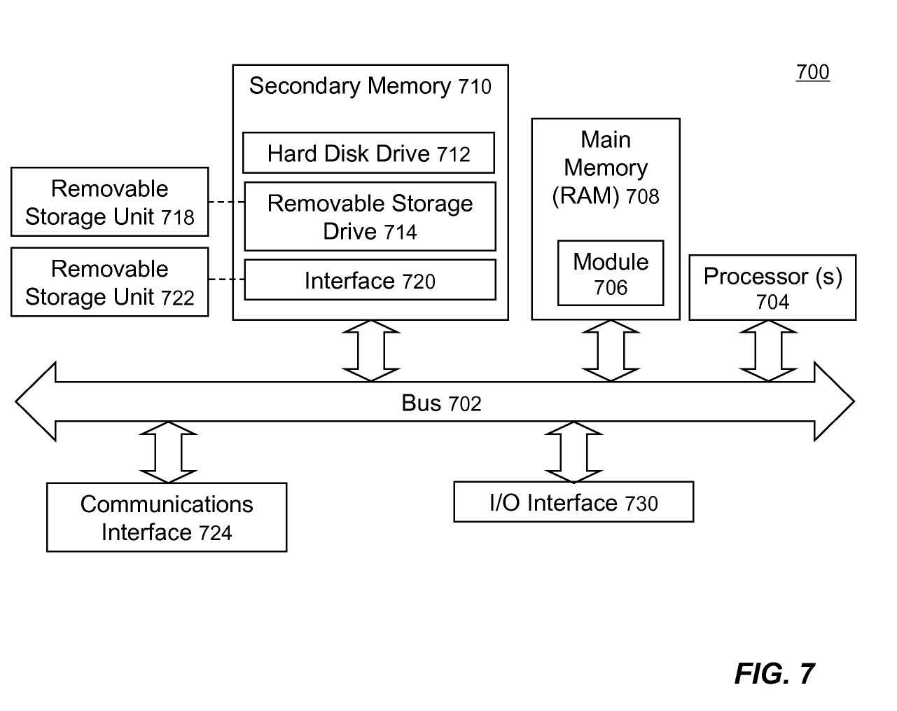

According to one aspect, the present invention is directed towards one or more computer systems capable of carrying out the functionality described herein. An example of a computer system 700 is shown in FIG. 7. The computer system 700 includes one or more processors, such as processor 704. The processor 704 is connected to a computer system internal communication bus 702. Various software embodiments are described in terms of this exemplary computer system. After reading this description, it will become apparent to a person skilled in the relevant art(s) how to implement the invention using other computer systems and/or computer architectures.

Computer system 700 also includes a main memory 708, preferably random access memory (RAM), and may also include a secondary memory 710. The secondary memory 710 may include, for example, one or more hard disk drives 712 and/or one or more removable storage drives 714, representing a floppy disk drive, a magnetic tape drive, an optical disk drive, etc. The removable storage drive 714 reads from and/or writes to a removable storage unit 718 in a well-known manner. Removable storage unit 718, represents a floppy disk, magnetic tape, optical disk, etc. which is read by and written to by removable storage drive 714. As will be appreciated, the removable storage unit 718 includes a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 722 and interfaces 720 which allow software and data to be transferred from the removable storage unit 722 to computer system 700. In general, Computer system 700 is controlled and coordinated by operating system (OS) software, which performs tasks such as process scheduling, memory management, networking and I/O services. Exemplary OS includes Linux®, Microsoft Windows®.

There may also be a communications interface 724 connecting to the bus 702. Communications interface 724 allows software and data to be transferred between computer system 700 and external devices. Examples of communications interface 724 may include a modem, a network interface (such as an Ethernet card), a communications port, a Personal Computer Memory Card International Association (PCMCIA) slot and card, etc. Software and data transferred via communications interface 724 are in the form of signals 728 which may be electronic, electromagnetic, optical, or other signals capable of being received by communications interface 724. The computer 700 communicates with other computing devices over a data network based on a special set of rules (i.e., a protocol). One of the common protocols is TCP/IP (Transmission Control Protocol/Internet Protocol) commonly used in the Internet. In general, the communication interface 724 manages the assembling of a data file into smaller packets that are transmitted over the data network or reassembles received packets into the original data file. In addition, the communication interface 724 handles the address part of each packet so that it gets to the right destination or intercepts packets destined for the computer 700.In this document, the terms “computer program medium” and “computer usable medium” are used to generally refer to media such as removable storage drive 714, and/or a hard disk installed in hard disk drive 712. These computer program products are means for providing software to computer system 700. The invention is directed to such computer program products.

The computer system 700 may also include an input/output (I/O) interface 730, which provides the computer system 700 to access monitor, keyboard, mouse, printer, scanner, plotter, and alike.

Computer programs (also called computer control logic) are stored as application modules 706 in main memory 708 and/or secondary memory 710. Computer programs may also be received via communications interface 724. Such computer programs, when executed, enable the computer system 700 to perform the features of the present invention as discussed herein. In particular, the computer programs, when executed, enable the processor 704 to perform features of the present invention. Accordingly, such computer programs represent controllers of the computer system 700.

In an embodiment where the invention is implemented using software, the software may be stored in a computer program product and loaded into computer system 700 using removable storage drive 714, hard drive 712, or communications interface 724. The application module 706, when executed by the processor 704, causes the processor 704 to perform the functions of the invention as described herein.

The main memory 708 may be loaded with one or more application modules 706 that can be executed by one or more processors 704 with or without a user input through the I/O interface 730 to achieve desired tasks. In operation, when at least one processor 704 executes one of the application modules 706, the results are computed and stored in the secondary memory 710 (i.e., hard disk drive 712). The status of the CAE analysis (e.g., progress of a particular engineering simulation) is reported to the user via the I/O interface 730 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas a sequence of metal forming simulations have been shown and described as an example of a series of hierarchical related engineering simulations, other engineering simulations may also be used in the invention, for example, a sequence of manufacturing process of an engineer product. Furthermore, whereas finite element analysis has been described and shown for stress analysis, other types of CAE analysis such as finite difference analysis or mesh-free analysis, etc. may be used to achieve the same. In summary, the scope of the invention should not be restricted to the specific exemplary embodiments disclosed herein, and all modifications that are readily suggested to those of ordinary skill in the art should be included within the spirit and purview of this application and scope of the appended claims.

What is claimed is:

1. A method of selecting a finite element analysis (FEA) solver with appropriate numerical precision in a series of hierarchically related engineering simulations comprising:
(a) receiving an input file at a computer system with both single precision and double precision FEA executable modules installed thereon, wherein the input file is for a particular one of the series of hierarchically related engineering simulations;
(b) extracting a simulation type from the received input file;
(c) determining which one of the single and the double precision FEA modules to be selected according to a predefined correlation of the simulation type and FEA module type;
(d) performing FEA using the selected FEA module for said particular one of the series of hierarchically related engineering simulations; and
(e) repeating steps (a)-(d) until all simulations have been performed in the series of hierarchically related engineering simulations.

2. The method of claim 1, wherein the input file comprises information of a structural product to be simulated.

3. The method of claim 1, wherein the series of hierarchically related engineering simulations comprises a sequence of metal forming simulations.

4. The method of claim 3, wherein the sequence of metal forming simulations comprises phases of gravity loading, binder wrapping, punch lowering, springback and edge flanging.

5. The method of claim 1, wherein the simulation type comprises one of implicit FEA and explicit FEA.

6. The method of claim 5, wherein the explicit FEA is conducted using the single precision FEA executable module.

7. The method of claim 5, wherein the implicit FEA is conducted using the double precision FEA executable module.

8. The method of claim 1, further comprises defining a simulation sequence command in the input file as a single identifier to trigger the series of hierarchically related engineering simulations.

9. A system for selecting a finite element analysis (FEA) solver with appropriate numerical precision in a series of hierarchically related engineering simulations comprising:
an input/output (I/O) interface;
a memory for storing computer readable code for application module that contain a single precision FEA module and a double precision FEA module; and
at least one processor coupled to the memory, said at least one processor executing the computer readable code in the memory to cause the application module to perform operations of:
(a) receiving an input file for a particular one of the series of hierarchically related engineering simulations;
(b) extracting a simulation type from the received input file;
(c) determining which one of the single and the double precision FEA modules to be selected according to a predefined correlation of the simulation type and FEA module type;
(d) performing FEA using the selected FEA module for said particular one of the series of hierarchically related engineering simulations; and
(e) repeating steps (a)-(d) until all simulation have been performed in the series of hierarchically related engineering simulations.

10. The system of claim 9, wherein the simulation type comprises one of implicit FEA and explicit FEA.

11. The system of claim 10, wherein the explicit FEA is conducted using the single precision FEA executable module.

12. The system of claim 10, wherein the implicit FEA is conducted using the double precision FEA executable module.

13. The system of claim 9, further comprises defining a simulation sequence command in the input file as a single identifier to trigger the series of hierarchically related engineering simulations.

14. The system of claim 9, wherein the series of hierarchically related engineering simulations comprises a sequence of metal forming simulations.

15. The system of claim 14, wherein the sequence of metal forming simulations comprises phases of gravity loading, binder wrapping, punch lowering, springback and edge flanging.

16. A computer usable medium having computer a readable medium stored thereon to perform a method of selecting a finite element analysis (FEA) solver with appropriate numerical precision in a series of hierarchically related engineering simulations comprising:
(a) computer readable code for receiving an input file at a computer system with both single precision and double precision FEA executable modules installed thereon, wherein the input file is for a particular one of the series of hierarchically related engineering simulations;
(b) computer readable code for extracting a simulation type from the received input file;
(c) computer readable code for determining which one of the single and the double precision FEA modules to be selected according to a predefined correlation of the simulation type and FEA module type;
(d) computer readable code for performing FEA using the selected FEA module for said particular one of the series of hierarchically related engineering simulations; and
(e) computer readable code for repeating steps (a)-(d) until all simulation have been performed in the series of hierarchically related engineering simulations.

17. The computer usable medium of claim 16, further comprises computer readable code for defining a simulation sequence command in the input file as a single identifier to trigger the series of hierarchically related engineering simulations.

18. The computer usable medium of claim 16, wherein the series of hierarchically related engineering simulations comprises a sequence of metal forming simulations.

19. The computer usable medium of claim 18, wherein the sequence of metal forming simulations comprises phases of gravity loading, binder wrapping, punch lowering, springback and edge flanging.
